(19) United States
(12) Patent Application Publication
(10) Pub. No.: US 2006/0195353 A1
(43) Pub. Date: Aug. 31, 2006

(54) Lead generation method and system

(76) Inventors: David Goldberg, Fairfield, CT (US); Steven Wolk, Chappaqua, NY (US); Charles A. Eldering, Furlong, PA (US)

Correspondence Address: TECHNOLOGY, PATENTS AND LICENSING, INC., 2003 South EASTON ROAD, SUITE 208, DOYLESTOWN, PA, 18901, US

(21) Appl. No.: 11/351,871

(22) Filed: Feb. 10, 2006

Related U.S. Application Data
(60) Provisional application No. 60/651,793, filed on Feb. 10, 2005.

(51) Int. Cl. G06F 17/30

(52) U.S. Cl. 705/10

(57) ABSTRACT

A method of lead generation includes receiving a question from a consumer and forwarding the question to one or more subscribers to the system. One or more of the subscribers may respond to the question. The subscribers may review the questions from the consumers and decide whether to respond to one or more of the received questions. The subscribers are charged to respond to the question. The consumer is notified of the responses from the subscribers that choose to respond. Alternatively, the responses are presented to the consumer.

### CROSS REFERENCE TO RELATED APPLICATION

This application claims the benefit of U.S. Provisional Patent Application No. 60/651,793 filed Feb. 10, 2005, and entitled “E Answer Engine” the entire disclosure of which is herein incorporated by reference.

This application is related to co-pending U.S. application Ser. No. ______ (Attorney Docket No. ASL-002-US; Express Mail Label No. EQ 411797771 US), filed Feb. 10, 2006, and entitled “Method and System for Demand Pricing of Leads”; and co-pending U.S. application Ser. No. ______ (Attorney Docket No. ASL-003-US; Express Mail Label No. EQ 411797785 US), filed Feb. 10, 2006, and entitled “Information Request System and Method”, the entire disclosures of which are incorporated herein by reference.

### COPYRIGHT NOTICE AND AUTHORIZATION

Portions of the documentation in this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND OF THE INVENTION

Traditionally, businesses, organizations and other similar entities, have relied on expensive, inefficient and inadequate methods to advertise and market their products or services. Historically, one primary manner of marketing included telephone book advertisements and/or listings. However, a basic quarter column advertisement in the Yellow Pages can cost thousands of dollars, placing such an ad is no guarantee to generate any business, and once the ad is printed it cannot be edited. Additionally, businesses of all sizes, in particular small businesses, often find it difficult and expensive to respond to sales-related phone calls during a business day, since doing so takes valuable time away from performing revenue generating work to respond to such calls. However, if the businesses do not respond to these inquiries, they risk losing potential sales opportunities. Similarly, the businesses may lose opportunities if they are overwhelmed with too many phone calls arriving at the same time. For example, many people call companies during the same lunch hour to inquire about their services. More recent methods of marketing, such as placing ads on Internet sites and search engines, are complicated, expensive and often ineffective. For example, Internet ads are easily prone to click fraud. Additionally, Internet methods typically do not permit businesses to choose which leads, hits or inquiries they wish to act upon. That is, Internet marketing services generally charge a fee to the business to forward unwanted leads or hits or leads with a low probability of producing sales to the business. Moreover, because the Internet has no geographical boundaries, Internet ads tend to attract people from outside a business's service area. For example, a consumer in Australia could click on a New York wedding photographer's advertisement on Google, costing that photographer's business money. Of course, it is highly unlikely that the Australian consumer would actually engage the New York photographer.

Similarly, consumers have their own challenges. Although consumers desire to utilize businesses that are local to their service location, or research the appropriate entity or organization to provide the products and services that the consumer needs, consumers frequently do not know where to find businesses that can provide the desired products or services, who is qualified to serve the consumer, or how to quickly and accurately obtain answers and/or desired information regarding the activities, products or services in which they have an interest. Internet research, such as through Google or Yahoo!, takes time and is often inefficient for obtaining specific answers and information. Consumers often have questions that are specific or relevant to the product or service being sought, such as “what should I look for when I am hiring an electrician for lighting work?” or “which photographers in my area have experience taking black and white pictures of children?” or have concerns that are particular to a specific geographic area. The Yellow Pages does not provide this information—multiple calls to potential vendors may provide some information, but obtaining specific information from multiple businesses (through whatever means), generally takes time, energy and, often money. Furthermore, even if a consumer does contact a potential vendor, that consumer has no idea as to the reliability and/or quality of that vendor.

### BRIEF SUMMARY OF THE INVENTION

The present method and system provides a lead generation and answer engine that allows consumers to ask a free-form question of subscribers to the system, such as business entities or local organizations and receive customized responses or answers containing human analysis of or human knowledge related to the content of the question in return from the subscribers. The consumers thus use the responses to make intelligent, informed purchase and research decisions. Consumers may pay to ask a question and/or gain access to a response or answer. Use of the system by the consumers may also be free. Subscribers may pay a fee to receive questions, submit an answer to one or more of the consumers' questions and/or have their answer delivered to the consumer. The subscribers have the ability to evaluate a question and determine, prior to responding to a consumer's question or request, whether the subscriber is actually interested in responding to that consumer, and therefore, whether that subscriber is actually interested in having that consumer as a client. The subscribers thus have an opportunity to exhibit their knowledge and professional abilities relevant to a particular industry or market, and at the same time, market their business, product or services and potentially gain a new customer.

By allowing potential consumers to anonymously ask questions of subscribers to the system about a wide variety of issues from dentistry to plumbing and for the subscribers to answer those questions, the present method and system generates “hot”, geographically relevant leads for the subscribers and provides consumers with expert advice from vendors they may want to hire. Consumers have the benefit of knowing that the answers or responses they receive from the subscribers were generated with some degree of human intervention or analysis and that such responses are likely from subscribers who not only want their business, but are serious about obtaining it.

The present method and system is also applicable to non-Internet users, as the lead generation and answer engine of the present method and system is available to ask questions and receive answers by phone, email or any other method of communication generally known in the art. The various forms of communication applicable to the lead generation and answer engine are available to both consumers and subscribers.

According to a first preferred embodiment of the present method and system, a method of lead generation includes receiving a question from a consumer and forwarding the question to one or more subscribers to the system. One or more of the subscribers may respond to the question. Preferably, the subscribers may review the question(s) from the consumers and individually determine whether to respond to one or more of the received questions. The subscribers are charged a fee to respond to the question. The consumer is notified of the responses from the subscribers that choose to respond. Alternatively, the responses are presented to the consumer. In one embodiment, the subscribers are charged the fee when the response is presented to the consumer that asked the question.

In one embodiment, the subscribers are charged a fee to receive the question(s) from the consumer. In another embodiment, the subscribers are charged a fee for access to the consumer that asked the question.

In another preferred embodiment, the consumer selects at least a subset of the available subscribers to which the question is forwarded.

According to another preferred embodiment of the present method and system, a method of lead generation includes receiving a question from a consumer and generating a response to the question. One or more subscribers may elect to sponsor the response to the question, and are charged for their sponsorship. Preferably, the subscribers may review the question(s) prior to deciding whether to sponsor the response. The consumer is notified of the responses.

In one embodiment, the responses are presented to the consumer. In another embodiment, the subscribers are not charged to sponsor the response unless the response is presented to the consumer.

According to another preferred embodiment of the present method and system, a system for generating a lead includes a first receiver for receiving a question from a consumer. A forwarding engine forwards the question from the consumer to one or more subscribers of the system. A second receiver receives responses from subscribers that choose to respond to the question. Preferably, the content of the response is based on human analysis of the content of the question by the subscriber that provides the response. A debiting system charges the subscribers to respond to the question, and a reply engine notifies the consumer of the response.

According to another preferred embodiment of the present method and system, in an Internet-based system through which subscribers are contractually obligated to advertise or make purchases, a method of lead generation includes receiving a question from a consumer. The question is forwarded to one or more subscribers to the system. A response to the question is received from subscribers who choose to answer the question. The subscribers respond to the question for free and the response is preferably presented to the consumer for free. Since the subscribers are under a contractual obligation to the system, the providing of a response to a question is accomplished in exchange for the subscriber that provided the response maintaining, performing or satisfying at least one of its contractual obligations to the system. Alternatively, such response could be presented in exchange for the subscriber undertaking a contractual obligation to the system.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown.

In the Drawings:

FIG. 1 is a UML use case diagram of the lead generation and answer engine in accordance with a preferred embodiment of the present method and system;

FIG. 2 is a UML association class diagram of the consumer class and the subscriber class for the lead generation and answer engine of FIG. 1;

FIG. 3 is a flow chart illustrating the process of asking a question in accordance with a preferred embodiment of the present method and system;

FIG. 4 is a flow chart illustrating the process of forwarding questions to subscribers in accordance with a preferred embodiment of the present method and system;

FIG. 5 is a flow chart illustrating the process of answering a question in accordance with a preferred embodiment of the present method and system;

FIG. 6 is an illustration of a computer system on which the present method and system can be realized; and

FIG. 7 is a network diagram of the lead generation and answer engine in accordance with a preferred embodiment of the present method and system.

### DETAILED DESCRIPTION OF THE INVENTION

Certain terminology is used herein for convenience only and is not to be taken as a limitation on the present invention. In the drawings, the same reference letters are employed for designating the same elements throughout the several figures.

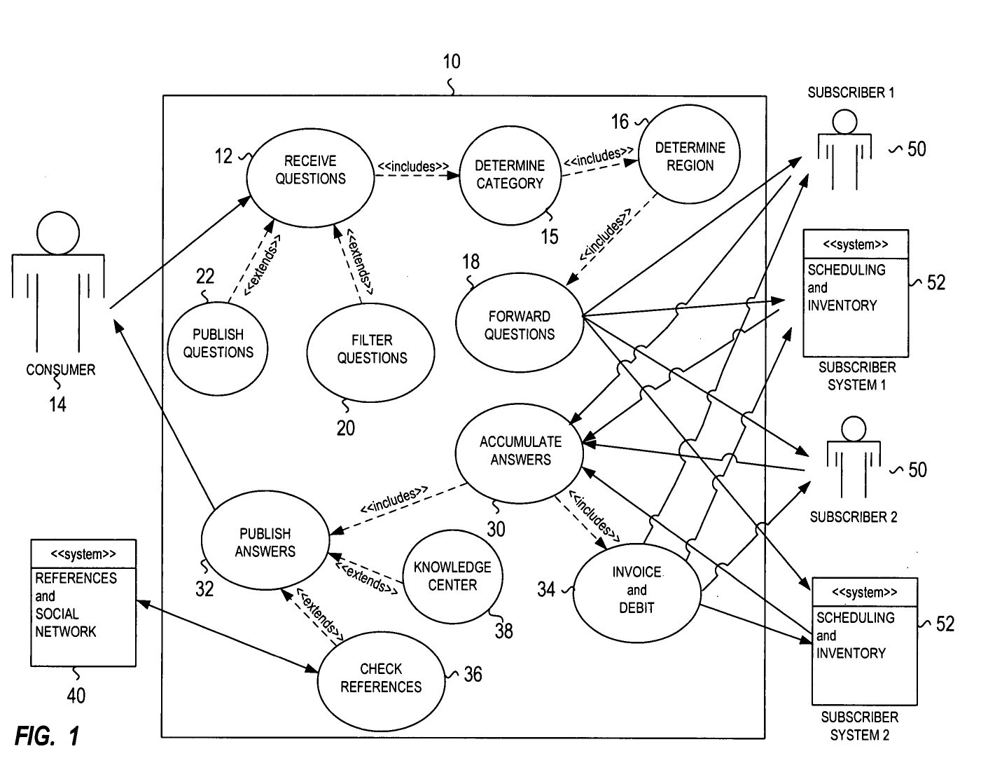

FIG. 1 illustrates a Unified Modeling Language (“UML”) use-case diagram for the lead generation and answer engine and associated systems and actors in accordance with the present method and system. UML can be used to model and/or describe methods and systems and provide the basis for better understanding their functionality and internal operation as well as describing interfaces with external components, systems and people using standardized notation. When used herein, UML diagrams including, but not limited to, use case diagrams, class diagrams and activity diagrams, are meant to serve as an aid in describing the present method and system, but do not constrain its implementation to any particular hardware or software embodiments. Unless otherwise noted, the notation used with respect to the UML diagrams contained herein is consistent with the UML 2.0 specification or variants thereof and is understood by those skilled in the art.

The lead generation and answer engine 10 according to the present method and system allows consumers to ask a question or make a request relevant to one or more categories and/or sub-categories and particular to a specific geographic area and potentially receive one or more answers or responses to that question from a subscriber to the system. More specifically, a consumer's question may be directed to one or more of a wide variety of topics, industries, or service areas for which the consumer is seeking an answer, advice, help or a service or product provider. Through the lead generation and answer engine of the present method and system, service and product providers or subscribers to the system have the opportunity to receive questions from one or more consumers using the system and, potentially, answer one or more of those questions if the subscriber so chooses. Preferably, subscribers are charged a fee to receive questions or requests, provide responses or answers and/or have their responses delivered to the consumers. In providing a response to a consumer's lead, subscribers are also able to include an advertisement, contact information or other marketing material relevant to their business, product or service. Consumers preferably use the system for free, although those skilled in the art will recognize that consumers could be charged a fee to utilize the system as well.

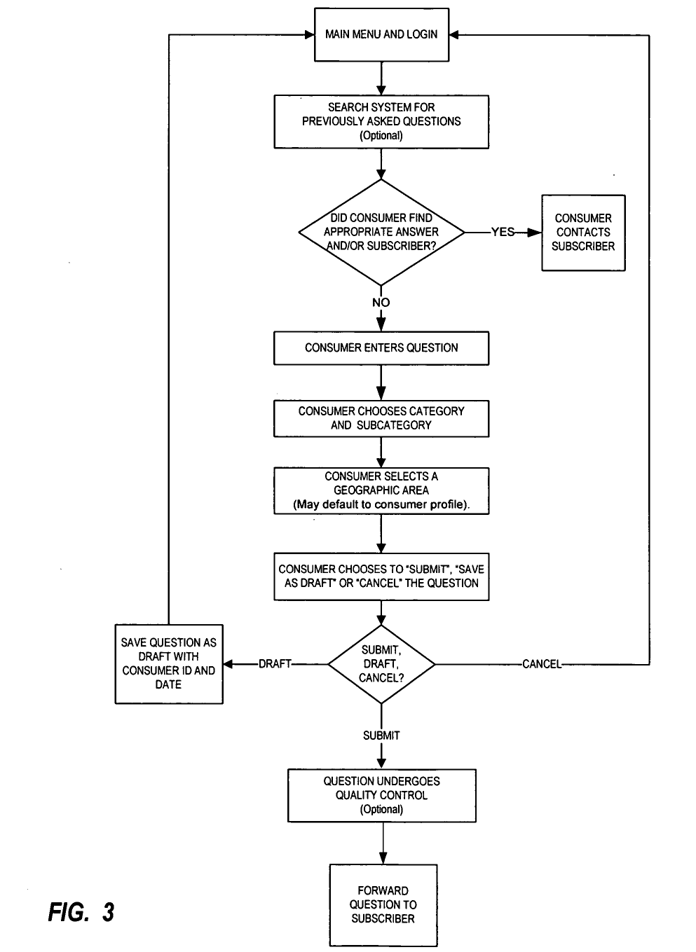

Referring to FIGS. 1-5 and 7, the lead generation and answer engine 10 includes a receive questions use case 12, through which a consumer 14 preferably interacts with the lead generation and answer engine 10. The flow diagram of FIG. 3 illustrates a typical process of entering questions through the receive questions use case 12 in accordance with the present method and system. The receive questions use case 12 preferably includes a user interface (not shown) such as an Internet-based application or web page (or combination of such pages), computer system or network, telephone or other application known in the art that is networked with or provides connectivity to the lead generation and answer engine 10. The receive questions use case 12 preferably includes features to grant the consumer 14 access to the lead generation and answer engine 10 (e.g., login features), create consumer accounts on the system, receive, document and update consumer profile information (e.g., user preferences, account information, consumer demographic and location information) and/or provide support for a consumer who already has an account with the lead generation and answer engine 10. Login, preference and profile features, applications and variations thereof are well known in the art, and a discussion thereof is omitted herein for convenience only, and should not be considered limiting.

The consumer 14 preferably inputs a question and/or request to the lead generation and answer engine 10 via the receive questions use case 12. As used herein, a question may be any statement, query, inquiry, request or other interrogative clause that generally seeks information, or which further clarifies the information requested by another question. The question may be of any suitable length or format. Thus, a question need not be a clause terminated by a question mark, nor does a question have to utilize proper grammar to be accepted by the receive questions use case 12. More than one question may be entered in a single input. Alternatively, the receive questions use case 12 may limit the number of words or characters input in connection with a particular question. Preferably, a question entered by a consumer is free-form in nature. That is, the question or request is preferably in the words of the individual consumer(s) making the request, and is not selected from a pre-defined list of questions. Alternatively, those skilled in the art will recognize that the entered question could be one which is pre-stored within the lead generation and answer engine 10, on a device associated with the lead generation and answer engine 10 or on a device local to the consumer 14 such that the pre-stored question is accessible to the retrieve questions use case 12.

In one embodiment, questions are input to the system using one or more pre-defined forms that may be created as generic templates or customized for various types of categories and/or geographical areas.

In one embodiment, the consumer is able to derive or utilize questions from a list or database of stored questions that are relevant to a particular type of subscriber, category, sub-category and/or geographic area. For example, the present method and system may include a list of sorted questions that are commonly asked of a particular type of subscriber.

Preferably, the receive questions use case 12 receives information from the consumer 14 in text format in a manner generally known in the art. For example, the information may be input by the consumer 14 through a keyboard, mouse or other computer input device known in the art. Alternatively, the question could comprise a text message (e.g., electronic mail) or may be in a file format uploaded or downloaded from a media storage device. In an alternative embodiment, the receive questions use case 12 receives information in audio or voice (e.g., from a telephone) format from the consumer 14. In still another embodiment, the receive questions use case 12 receives information in graphical format, including video, pictures, photographs or other images in a suitable format. Those skilled in the art will recognize that the information may be received by the receive questions use case 12 in any one or combination of formats and/or file transfer protocols generally known in the art. Additionally, the receive questions use case 12 may receive information directly or indirectly from the consumer 14, another computer system or network without departing from the spirit and scope of the present invention. The question may also be input to the receive questions use case 12 as some combination of text (or other format) and an accompanying file attachment. For example, the consumer 14 could type a text question and attach an audio, graphical, text and/or any other type of file to the entered question to provide the potential answerer (i.e., subscriber) with a better understanding of the context of the question, problem or request.

The lead generation and answer engine 10 preferably includes a determine category use case 15, through which the consumer 14 assigns or associates the entered question or request to one or more keywords, categories or topics. Preferably, the consumer selects one or more categories that are related to, or correspond to, the entered question or request. Preferably, the category is selected from a predetermined list of keywords or topics provided by the determine category use case 15. The determine category use case 15 preferably also provides for the selection or entry of a sub-category based on the selected or entered category. The consumer preferably selects the relevant keyword(s) from a series of pull-down menus provided by the determine category use case 15, although other methods of specifying the keyword(s) generally known in the art may be utilized. The question entered by the consumer may or may not be actually related to the selected category. That is, a category is assigned or designated by the consumer 14, from which the lead generation and answer engine determines which subscribers receive the question.

In one embodiment, the consumer 14 is able to submit a customized or proposed keyword or topic to be used by the determine category use case 15 or that is to be added to the pre-defined list of keywords. For example, if a consumer 14 enters a customized keyword, the lead generation and answer engine 10 may determine whether to add the proposed keyword to the pre-defined list. If not, the lead generation and answer engine 10 preferably selects which of the existing keywords the entered question should be associated with.

The lead generation and answer engine 10 preferably further includes a determine region use case 16. The determine region use case 16 is preferably employed in conjunction or combination with the retrieve questions and determine category use cases 12, 15 and permits the consumer 14 to select or specify a geographic region or area to which the entered question applies and/or for which service or the answer is being sought. Preferably, the question entered by the consumer is relevant to a particular geographic area, thus ideally warranting an answer or response from a subscriber, vendor or service provider located within, capable of servicing or at least knowledgeable about that particular geographic area. For example, if the consumer's question is directed to a plumbing problem for a summer home, the question will preferably be answered by a subscriber located in (or a subscriber that services) the region in which the summer home is located—not the location of the consumer asking the question. The consumer preferably selects the relevant geographic area from a series of pull-down menus provided by the determine region use case 16, although other methods of specifying the geographic region generally known in the art may be utilized. Those skilled in the art will recognize that any degree of geographic specificity and/or any available geographic filter may be utilized. For example, the determine geographic region use case 16 may specify by city, state, region, country, zip code, area code, or any combination thereof. In another example, the consumer may specify, or the system may default to (based, for example, on the consumer's preference profile), a zip code. The consumer may then further specify a radius with respect to that zip code for which entered question applies. In an alternative embodiment, the consumer may enter a question or request without specifying a particular geographic region to which the question is directed.

In one embodiment, the consumer does not need to manually enter the question and/or keyword(s) and geographic area to the receive questions use case 12. For example, the consumer may email a question to the lead generation and answer engine 10, such that the keyword(s) or topics and/or the geographic area in the subject line of the email are recognized by the receive questions use case 12 as the relevant subject and geographic areas. Those skilled in the art will recognize that the receive questions use case 12 of the present method and system may parse the heading or body of the email and automatically import and/or determine the keyword(s), question and geographic information to the lead generation and answer engine as determined from the entire email text. A question received in such a manner may also then be automatically forwarded to appropriate subscribers according to the determined keyword(s) and/or geographic area.

Questions entered by a consumer 14 (and, if appropriate, the keyword and geographic location) are preferably published or made publicly available in publish questions use case 22. For example, questions entered by consumers 14 may be posted to an Internet accessible web page, forum, knowledge center or other application controlled by the lead generation and answer engine 10, such that visitors to the application can review the categories, topics and questions as well as answers that may have already been provided to those questions, as discussed in greater detail below. The public may also be able to access this information through other forms of communication, such as telephone. Preferably, any questions made publicly viewable through publish questions use case 22 maintain the anonymity of the consumer 14 that submitted the question. That is, although the lead generation and answer engine 10 preferably associates the question with a particular consumer, the viewing public is preferably not able to determine who asked the question or other information about the consumer, since private information (e.g., name, email address, street address, and other contact information) is not published along with the question.

A filter questions use case 20 preferably evaluates questions entered by consumers for quality control purposes, including such aspects as unacceptable words or phrases (e.g., profanity, insults), completeness, length, etc. If necessary, the filter questions use case 20 prevents unacceptable questions from being received through the receive questions use case 12. Additionally, the filter questions use case 20 may evaluate the question to determine if the entered information includes any contact or other personal information about the consumer. In such a case, the filter questions use case 20 may remove the personal or contact information or prevent the question from being received.

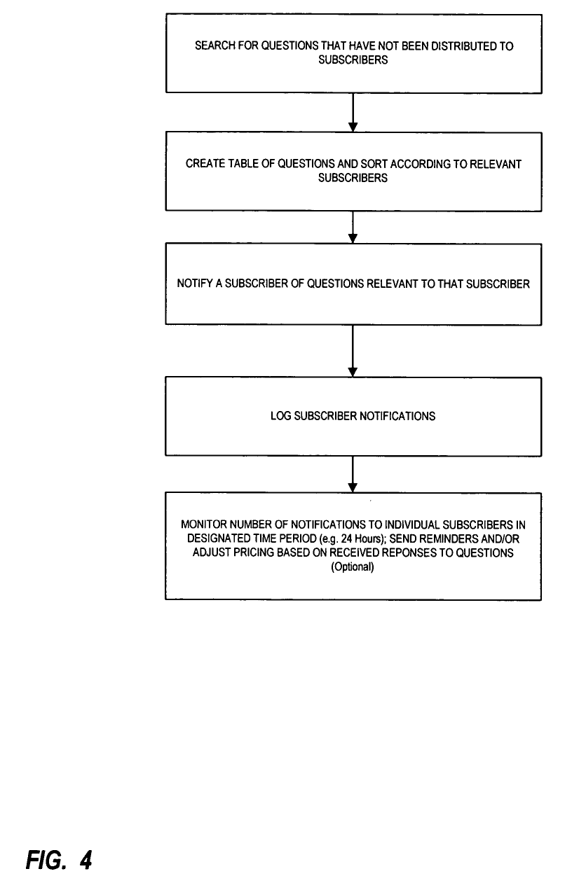

The lead generation and answer engine 10 further includes a forward questions use case 18 for distribution of the question(s) to one or more subscribers 50 to the lead generation and answer engine 10. The flow diagram of FIG. 4 illustrates a typical process of forwarding questions to subscribers through the forward questions use case 18 in accordance with the present method and system.

A subscriber 50 is preferably an individual, group, business entity or other organization that identifies with one or more particular trades, services or industries. Preferably, a subscriber has a place of business in, or services one or more, particular geographic areas. For example, a subscriber may be a plumber that services several local zip codes, a national clothing store that has a store within a geographic region, but which services customers nationally, or an organization that has a single headquarters, but which serves all geographic areas. The forward questions use case 18 preferably forwards questions only to subscribers that have registered with the lead generation and answer engine 10. That is, although questions entered by consumers 14 may be publicly viewed through the publish questions use case 22, in the present method and system, the submitted questions are preferably not distributed to the public at large. Thus, preferably, people or entities that are not subscribers to the lead generation and answer engine 10 (i.e., non-subscribers) do not receive notification of a question; non-subscribers have to access the publish questions use case to initially find out about the questions. Preferably, subscribers 50 register with the lead generation and answer engine 10 in a manner similar to the registration of consumers 14. Thus, subscribers provide relevant contact, profile, industry, geographic, business, billing, fee, preference and other information to the lead generation and answer engine 10.

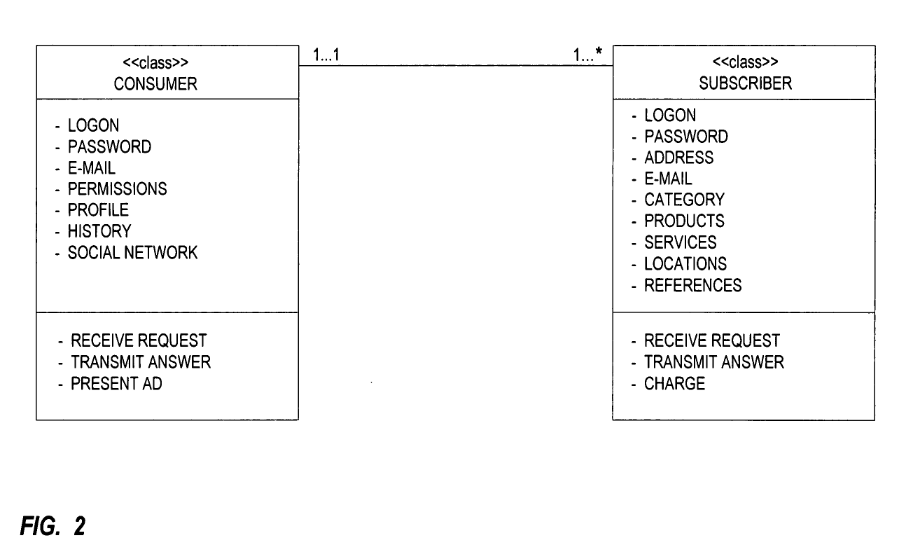

FIG. 2 represents an association class diagram showing the class relationship between consumers 14 and subscribers 50 in the present method and system. More specifically, FIG. 2 indicates the some of the attributes for each of the consumer and subscriber classes, as well as examples of the operations that may be performed on those classes.

In one embodiment, if the consumer 14 enters a question for which there are no appropriate subscribers, the lead generation and answer engine 10 preferably contacts through telephone, email or other means, appropriate non-subscribers in an attempt to offer the question and/or have the consumer's question answered.

A subscriber 50 is preferably interested in receiving, reviewing, and potentially providing responses to questions input to and distributed by the lead generation and answer engine 10, perhaps with an expectation of advertising their goods or services to the customer 14 with the possible result that the consumer may utilize the subscriber's services or purchase goods or products from the subscriber 50. That is, answering or providing a response to a consumer's question (i.e., pursuing the consumer's lead or opportunity to answer or respond) may generate a business opportunity for the subscriber 50. If, for example, a subscriber 50 is a plumber, the subscriber preferably elects to receive questions that correspond to any number of keywords or topics that relate to plumbing issues. If a question is submitted by a consumer having a keyword related to a plumbing topic, or if the question has been assigned to the “plumbing” category, the question is automatically forwarded to the one or more subscribers that have elected to receive questions related to the plumbing topics or keywords. The distribution of questions by the forward questions use case 18 may be further refined by the geographic area associated with the question and/or availability of subscribers 50 that have identified themselves as servicing that particular geographic area.

Once a question has been entered by the consumer 14, questions are preferably automatically forwarded by the forward questions use case 18 to one or more of the subscribers 50 in any suitable fashion, preferably via electronic mail. In an alternative embodiment, the question itself need not be distributed to the subscribers 50, but rather notification of the question may be given to the subscribers 50, such that the subscribers 50 are prompted to visit a webpage (public or private) of the lead generation and answer engine 10 or some alternate system or network to review and/or respond to the question. For example, subscribers 50 may visit the application(s) controlled by publish use case 22 to view the questions listed thereon. The question or notification thereof is preferably distributed to the subscriber via email. However, those skilled in the art will recognize that other distribution methods, such as telephone or video link, may be used.

In one embodiment, the subscribers do not receive notification of asked questions. Rather, a subscriber and/or non-subscriber checks the lead generation and answer engine 10 (e.g., the publish questions use case 22) to determine if any questions with relevant keyword(s) and/or geographic area(s) have been recently posted.

Preferably, the subscribers 50 that receive a given question are subscribers that are relevant (or have so indicated) to the keyword(s) associated with the question and/or are within the geographic area(s) associated with the question.

In one embodiment, the consumer has the ability and option to choose from a list of subscribers to whom the lead generation and answer engine 10 will send the consumer's questions, such that the consumer may specifically select some or all of the subscribers who receive the questions. In another embodiment, the consumer has the ability to specify a non-subscriber to receive the entered question.

In one embodiment, the consumer is able to narrow the list of subscribers to which their questions forwarded according to a rating attributed to potential subscribers. For example, other consumers may have rated a subscriber based on that subscriber's answers to previous questions and/or that consumer's interaction with that subscriber (e.g., how that subscriber performed services or delivered products), how another consumer rated the subscriber, or how other consumers in aggregate rated the subscriber. Thus, a consumer may desire to only have subscribers that rate a 7 out of 10 or better (in conjunction with the relevant geographic and/or category criteria) to answer their question.

In many cases generally known in the art, self-proclaimed experts provide answers to questions regardless of their background. However, in accordance with one embodiment of the present method and system, subscribers must at least claim to be a subject matter expert or professional in the area in which they propose to answer a question and to offer some proof of their expertise. That is, the subscribers are required to “certify” that they are an expert, someone who engages professionally in the named category or industry or someone who is knowledgeable about the product or service relevant to the questions they receive and/or the questions they desire to answer. Such a certification process preferably takes place when the subscriber registers with the lead generation and answer engine, at the point when the subscriber selects or alters the categories (i.e., keywords) of questions desired for receipt, or when a subscriber attempts to answer a question within a particular category. The certification process may include, for example, a description of how long the subscriber has been in the field, what education or training they have, where appropriate, their relevant license number(s), and other similar information. A subscriber's certification (and supporting credentials) may be presented to consumers with the notification of the response and/or with the response itself. As part of the certification process, the subscribers may be required to read and/or sign a contract stating that they have truthfully participated in the certification process.

In one embodiment, the consumer question is forwarded to a subscriber that is an expert, but not necessarily a paid professional. That is, the question may be answered by someone who studies, learns, shares industry/service specific knowledge as an avocation. For example, when the consumer enters a question, the consumer may have the option to choose to “receive answers from professionals” and/or “from the public.”

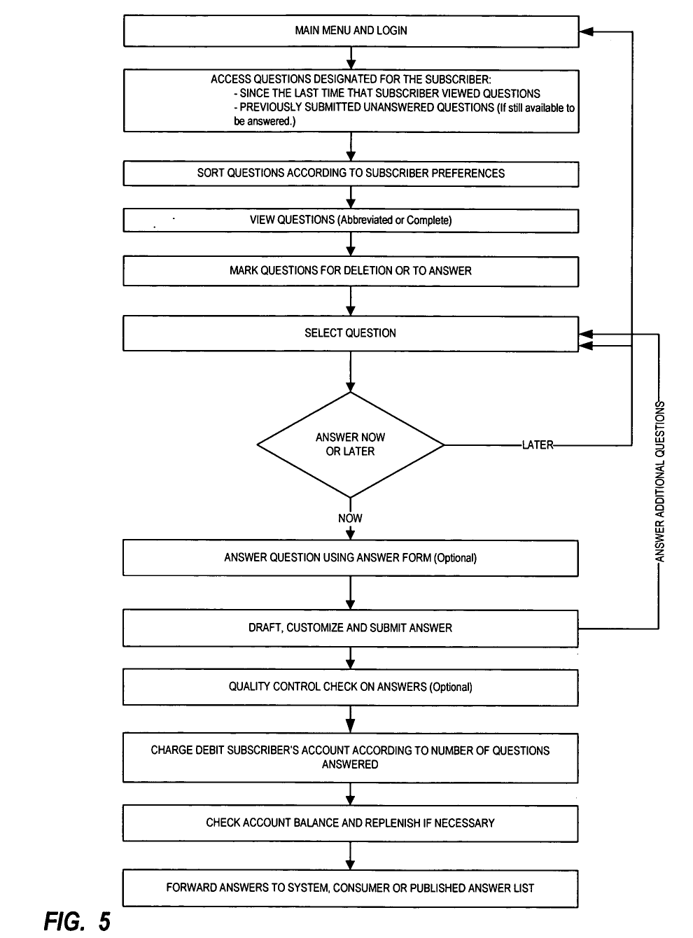

Subscribers 50 preferably have the ability and/or opportunity to review questions (or the notification thereof) received from the forward questions use case 18. The subscribers 50 choose whether or not to respond to any combination of the questions. That is, one subscriber may choose to answer all of the questions, whereas another subscriber (that receives an identical list of questions) may choose to answer only a few or none of the forwarded questions. Stated differently, a subscriber is under no obligation response to any of the consumers' questions. Since subscribers thus have the ability to positively select when and which questions the subscriber responds to, the subscribers have a significant degree of control over generating new (or continued) business from consumers. The flow diagram of FIG. 5 illustrates a typical process of evaluating and responding to questions through the accumulate answers use case 30 in accordance with the present method and system.

Subscribers 50 preferably respond to one or more questions through the accumulate answers use case 30, providing a customized answer or response to a question. Stated differently, the answers provided by the subscribers in the present method and system are preferably not pre-defined, generic responses that may be applicable to a multitude of different questions. Rather, the subscribers provide answers that contain at least some degree of human knowledge, analysis, thought and/or intervention in preparing a particular answer in response to a particular question. That is, subscribers preferably apply human analysis to the content or category of the question in preparing a response to that question. The subscribers may use answers that have been previously provided or even stored on one or more servers (not shown) of the lead generation and answer engine 10 for the purpose of responding to particular type of content or question. However, in the present method and system, a human preferably analyzes or evaluates the question and determines which answer to provide and what that response will contain. Those skilled in the art will recognize that an answer or response provided by a subscriber 50 need not be an actual, accurate or truthful answer to a consumer's question or request. That is, in the lead generation and answer engine 10 of the present method and system, there is not necessarily a “correct” answer or response.

In one embodiment, the public (i.e., self proclaimed experts, non-subscribers) has an opportunity to answer questions viewed through publish questions use case 22. Such answers may be provided to the accumulate answers use case 30 for a fee or free of charge.

The accumulate answers use case 30 preferably includes a subscriber interface, such as an Internet-based application or system (similar to that employed by the receive questions use case 12). Those skilled in the art will recognize that other subscriber interfaces through which answers are entered may be utilized. For example, the accumulate answers use case 30 may utilize an email response system, in which a subscriber answers a particular question by sending an email to the accumulate answers use case 30, without interfacing directly with the lead generation and answer engine 10.

In one embodiment, subscribers 50 interact with the lead generation and answer engine 10 using telephone or other voice communications. In this embodiment, the forward questions use case 18 preferably sends relevant questions to corresponding subscribers, such that the subscribers either receive a voice message that they have new questions from the lead generation and answer engine 10, or such that the subscribers 50 receive the actual question itself in voice format. Similarly, the subscribers may respond to the accumulate answers use case 30 by either voice, text or some combination thereof. Voice transcription services for voice to text conversion and text-to-voice software generally known in the art are employed by the lead generation and answer engine as necessary to accomplish these features. Alternatively, transcription services for text to speech, speech to text, or any other form of exchange may be accomplished through human means. Enabling voice and/or text communication among and between the consumers, subscribers and the lead generation and answer engine 10 according to preferences provides added versatility to the present method and system. For example, a subscriber such as a contractor, plumber or electrician may prefer to receive questions and generate answers over the telephone since they are likely to be away from a text device most of the day. Using telephone service to answer questions enables such subscribers to provide prompt and efficient answers to consumers throughout the day or at convenient points in the day, thereby benefiting both subscribers and consumers.

As discussed, in one embodiment, questions asked by a consumer 14 are preferably posted to a webpage of the lead generation and answer engine 10 through publish use case 22, such that a non-subscriber visitor to the website can review the question and provide a non-subscriber answer to the question as well, or so that other potential consumers 14 or subscribers 50 have the opportunity to review previously asked questions and corresponding answers. Preferably, answers provided by one or more subscribers 50 are also published or posted on the lead generation and answer engine 10 through publish answers use case 32. Similar to publish questions use case 22, publish answers use case 32 may be an Internet website or page controlled by the lead generation and answer engine 10, such that visitors to the website may view answers to questions. Preferably, answers provided by subscribers 50 are listed through publish answers use case 32 in relation to the question they answered. Answers may be posted in a list in any suitable arrangement that may include for example, order of receipt, date, time, or order of relevance.

In one embodiment, answers provided by subscribers are differentiated from non-subscriber responses. For example, subscriber responses may be posted in a priority order in the answer list, ahead of answers that are provided by non-subscribers. Alternatively, subscriber answers in the answer list could be highlighted or flagged. In one embodiment, subscriber answers are password protected or stored in a protected domain that is accessible to only a limited number of people (e.g., the consumer who asked the question). Alternatively, consumers' questions (and subsequent uploaded files) may also be password protected, so that only selected subscribers or consumers can view them.

The publish answers use case 32 preferably also examines the quality of answers provided by subscribers 50. The answers may be evaluated for quality and appropriateness, similar to the filter questions use case 20. If the answers do not pass either an automated or manual quality control process, such answers may be not be sent to the questioning consumer or used anywhere else in the lead generation and answer engine 10.

In one embodiment, when a consumer accesses subscriber answers, the consumer has the option of establishing a communication link with the subscriber. Such a communication link may be provided through the lead generation and answer engine 10, such as via email, voice or web-link, or external to the present method and system, such as through private email or telephone service.

In one embodiment, a subscriber 50 is able to respond in a direct manner through the lead generation and answer engine 10 (e.g., via email) to the consumer 14 that provided the question if the consumer's account (as defined by profile preferences) permits such a response. Although such an email response is processed through the lead generation and answer engine of the present method and system, such a response is essentially a direct response from subscriber to consumer since the consumer need do nothing more than check email to obtain responses. Consumers can also indicate at the time they ask a question that they want to override the profile and permit such a response. In responding to a question in such a manner, the privacy or anonymity of the consumer is still generally protected, since the subscriber 50 does not learn the consumer's email address or other personal or contact information, even though the subscriber emails the consumer. Such forwarding or response systems that maintain privacy are generally known in the art and a description thereof is omitted here for convenience only and should not be considered limiting. Thus, the consumer 14 receives a response from a subscriber that has a relationship or experience in the area that is the subject of the keyword and the question, thereby eliminating the need for the consumer to sort through and/or review various responses that have been posted to the lead generation and answer engine 10. Preferably, the consumer is also able to prevent further unwanted communications, solicitations or contact from a subscriber, even if the consumer had previously asked a question and received a response from a particular subscriber.

In one embodiment, the lead generation and answer engine 10 includes a check references use case 36 to help verify the authenticity or quality of an answer provided by a subscriber 50 and/or to help verify the qualities of the subscriber(s). In addition, the check references use case 36 helps provide and accumulate ratings that may be attributed to a particular subscriber for utilization by consumer, as discussed above. The check references use case 36 preferably accesses a references and social network system or database 40 that includes quality control and other general information about the subscriber community at large. In particular, the references and social network system 40 preferably includes information related to the quality of a subscriber's previous answers, the responsiveness and quality of any resulting product or service from that subscriber, as well as any other impressions gather about a particular subscriber. The references and social network system 40 may obtain its data from a combination of various sources, including local and regional business directories, consumer organizations and consumers themselves. Preferably, the references and social network system 40 is updated through the check references use case 36. The check references use case 36 may also be used to verify the quality and authenticity of a consumer's question input to the receive questions use case 12.

In another embodiment of the present method and system, the publish answers use case 32 includes a consumer forum in which questions and responses to those questions are stored for viewing or retrieval by consumers, subscribers and visitors (e.g., non-subscribers) to the lead generation and answer engine 10. The consumer forum may be filtered by many or all of the criteria described herein with respect to sorting or filtering questions and answers. In this manner, consumers have the ability to quickly search through known quality answers for subscribers in a designated area with respect to questions related to a specific problem, concern, product or service. That is, the consumer saves time in not having to wait for a customized answer from a subscriber, but also has the knowledge that the answer provided in the consumer forum underwent the same rigors as if the consumer had actually asked the question of multiple subscribers (e.g., geographic specificity, keyword question, professional response, knowledge that a subscriber paid to previously answer the question). Additionally, consumers may utilize the answers provided in the forum to assist in selecting which subscriber(s) that they prefer to answer their own question(s), or to help formulate what type and/or content of question to ask. The consumer forum benefits subscribers since they obtain continued exposure for providing quality answers to questions. Those skilled in the art will recognize that consumers could be charged a fee for accessing answers stored in the forum, or that subscribers could be charged a fee for storing an answer in the forum.

In one embodiment the consumer forum includes responses to questions that have been provided by non-subscribers as well as subscribers. Preferably, the consumer forum identifies whether the person or entity providing the response is a subscriber, so that the inquiring consumer knows how to ascertain the quality of the response.

In one embodiment, the publish answers use case 32 includes an answer library feature that stores previous answers given by subscribers. Thus, subscribers have the ability to select answers that they have already created for previous questions in an effort to answer questions just recently received. As such, subscribers are able to respond much more easily and efficiently to questions that are often forwarded to them. The answer library may automatically attempt to pre-select answers for a subscriber that seem to fit the question based, for example, on the category assigned to that question. For example, every time a consumer asks what she should do to grow grass in a shady area, a subscriber who is a landscaper can answer with the same generic (albeit previously customized and human analyzed) answer. Furthermore, using the answer library, a subscriber (e.g., a plumber) may create stock answers such that a junior member (e.g., a plumber's apprentice) could answer incoming questions by using the experienced, professional answers that the plumber himself created. This enables a subscriber to potentially use less expensive labor (or lower opportunity cost) in answering the questions while also speeding up the answering process.

In one embodiment, the lead generation and answer engine of the present method and system charges consumers and/or visitors to the system a fee for retrieving answers from the answer library. Such a fee could be charged on a per answer basis or could be to purchase an entire library of answers (e.g., answers related to an entire category and/or geographic area).

Similarly, consumers may automatically receive generic answers to common questions that have been previously answered. Such automatic answers may occur without any manual subscriber intervention. However, the appropriate subscriber(s) are still charged for providing an answer as if they had manually interacted with the question, as described in greater detail below. For example, if the forward questions use case 18 recognizes a question e.g., “I slipped and fell in a store and broke my collar bone, can I sue?”, the forward questions use case 18 preferably automatically instructs the accumulate answers use case 30 to respond to the question with an attorney's preset answer (for example, from the answer library) for this type of question and charge the attorney (assuming that the attorney's profile permits such an action).

The lead generation and answer engine 10 of the present method and system further provides a revenue generating system in invoice and debit use case 34. In one embodiment, subscribers 50 pay a fee to receive one or more questions related to one or more keywords of interest and/or geographic area designated by the subscriber. Additionally or alternatively, the lead generation and answer engine 10 may charge a fee to the subscriber when that subscriber initially receives or reviews the question, when that subscriber elects to respond to a question, and/or when that subscriber's response to the question is delivered or presented to the asking consumer. Fees for keyword questions and answering questions may be established by any suitable arrangement, and may be implemented through any debiting mechanism generally known in the art. For example, fees could be determined on a per-question or answer basis or be a flat fee to receive group of questions or provide a set number of answers.

Other fees that may be collected or fee structures that may be utilized through the invoice and debit use case 34 include, for example:
A fee charged to the subscriber to deliver a message (e.g., an answer) to a consumer or make the message available to that consumer in a manner of the consumer's choosing (e.g., telephone, email, etc . . . );
A fee charged to a subscriber when a consumer makes an inquiry of a product or service offered by that subscriber;
A fee to add the subscriber's answer (under the subscriber's name) to the consumer forum described above;
A fee to continue facilitating communications between the consumer and the subscriber, even after the consumer's initial question was answered by that subscriber. Such ongoing communications could be accomplished via email, phone, and may or may not be anonymous; and
A subscription fee (e.g. $10/month) to be a preferred subscriber to receive, for example, consumers' questions and/or have the right to answer those questions.

The fees associated with receiving keyword questions and/or for answering questions are preferably fixed as determined by the lead generation and answer engine 10. Such fees are preferably attributed to the appropriate subscriber through the invoice and debit use case 34. Alternatively, fees associated with receiving keyword questions and/or answering questions in the lead generation and answer engine 10 may be established through a bidding, auctioning or demand pricing process. For example, questions associated with popular keywords or categories (as known or measured over time) may command a higher fee from the subscribers 50.

In one embodiment, subscribers bid to provide responses to questions. For example, the right to answer questions (or have the responses presented to consumers) is awarded to a predetermined number of subscribers within a category and/or a geographic are that offer to pay the highest fee for the opportunity to answer questions within that category.

In one embodiment, subscribers create answers at different times after they receive a question from the lead generation and answer engine 10. Since the accumulate answers use case 30 in conjunction with the publish answers use case 32 determines the timing of notifying the consumer and/or publishing the answer, subscribers may bid on the timing of delivering the answer. That is, a subscriber may bid to be the first, second, etc., answer delivered to the asking consumer. Alternatively, if multiple answers to the same question are delivered to the consumer at the same time, a subscriber may bid on the position that his answer appears within the delivered answer list.

In an alternative embodiment, the number of answers that may be received by a consumer are limited (either through a preference of the consumer, or a setting of the lead generation and answer engine 10). In such a system, subscribers may bid to be included in the answer list generally. For example, if the consumer has set a preference to receive no more than five answers in response to a question, and the question was forwarded to more than five relevant subscribers, a subscriber may bid to have his answer included in the five answers that are returned to the consumer.

The invoice and debit use case 34 preferably is able to self-level pricing based on the demand over time to answer questions. That is, the invoice and debit use case 34 automatically adjusts a given fee associated with access to a question or the ability to answer in accordance with the averaged demand for a particular service. For example, if a legal question is distributed to ten medical malpractice attorneys and ten of those attorneys want to answer for $X over a designated period, the invoice and debit use case 34 concludes that there is great demand to answer such question, and that the price for access to those questions or answers should rise. The invoice and debit use case 34 raises the price in increments (for example, 25 cents), until an average of a predetermined number of answers per question in this category are obtained. Conversely, if there is little demand to answer, the self-leveling feature lowers the price. The self-leveling process may occur category by category and/or by category within a geographic area. Similarly, the self-level pricing feature of the invoice and debit use case 34 may adjust the fee charged to a subscriber based on the number of questions that are asked within a particular category over time. Alternatively, the self-level pricing may adjust fee charged to subscriber based on the demand to answer a particular question at a particular point in time.

In one embodiment, the fee charged to subscribers for receiving, accessing or responding to questions in the manner(s) described above is determined at least in part by the rating attributed to that subscriber. For example, if a subscriber has a relatively high rating (as attained, for example, through favorable consumer feedback in previous question responses), that subscriber might be charged a relatively low fee for the opportunity to respond to future questions. Similarly, if a subscriber has a relatively low rating (because, for example, the subscriber has given poorly written responses), that subscriber might be charged a relatively high fee to respond to questions. Assessing fees in this manner is preferably based on a subscriber rating that is averaged over time (i.e., not on a rating that is based on a low number of instances). Such a fee mechanism provides incentives to subscribers to provide quality responses and/or products and services to presumably increasing their rating, thereby lowering their advertising and response fees. As an individual subscriber's rating changes, the fee assessed to that subscriber changes accordingly. Such a mechanism also preferably lowers the number of unwanted (i.e., non-serious) subscriber participating in the lead generation and answer engine of the present method and system.

In another embodiment, the invoice and debit use case 34 preferably includes a tiered or variable pricing system that charges a different fee depending on the pricing tier that a particular subscriber is assigned to. For example, subscribers with a high rating and/or subscribers that frequently and actively participate (i.e., subscribers that respond to a large number of questions) in the lead generation and answer engine 10 in proper manner are assigned to the pricing tier that charges the lowest fee for receiving or responding to questions. Movement of subscribers between the pricing tiers depends on changes in the subscriber's rating, activity in the system, volume of questions received or answered, use of other services (e.g., consumer forum or knowledge center), and/or any other relevant factor related to the lead generation and answer engine 10 or the combination of one or more such factors.

In one embodiment, subscribers are contractually obligated with the lead generation and answer engine 10 or a portion thereof to purchase advertisements (or ad opportunities) and/or make purchases of goods and/or various other paid services, including for example website hosting and networking, therefrom. For example, a subscriber may be under a contract to advertise the subscriber's products or services (e.g., for a flat fee or a fee for a particular number of advertisements or hits thereon) on a particular website, application or system. In this embodiment subscribers are not charged a fee to receive questions, provide responses or have those responses presented to consumers. However, since the subscribers are contractually obligated to the system or system manager, the providing of a response to a question asked by a consumer is accomplished in exchange for the subscriber that provided the response maintaining, performing or satisfying one or more of that subscriber's contractual obligations to the system. Alternatively, such response could be presented in exchange for the subscriber undertaking a contractual obligation to the system. For example, if a subscriber has contracted to utilize a predetermined number of advertisement opportunities on or through a website (for a fee payable to the website for each such advertisement used), the subscriber may be permitted to provide a response to a consumer's question free of charge in exchange for utilizing (and thus paying a fee) another service (e.g., using one or more of the subscriber's advertisement hits) of the website. In this manner, providing the response to the consumer for free could serve as a “loss leader” for the website or be a fringe benefit of the contractual obligation for the subscriber.

In an alternative embodiment, the subscribers are not contractually obligated to the system, but nonetheless are able to provide responses free of charge to consumers. For example, the system may offer subscribers the ability to generate and present responses free of charge on the premise that such subscribers will be more inclined to utilize the system for other products or services and/or promote the system's name, business and opportunities to others in the community (i.e., free advertising for the system).

In one embodiment, if a pre-determined number of answers are not produced by subscribers in a pre-determined amount of time, subscribers that have not yet answered receive a “second chance” notice to answer the question at a lesser price. If the pre-determined number of answers is still not produced by subscribers in a pre-determined amount of time, subscribers who have not answered receive a “final chance” notice to answer at a lesser price, perhaps even free. If the pre-determined number of answers are still not produced by subscribers, the consumer preferably receives a notice indicating as such, and is offered one or more options, including, but not limited to: “Rewrite your question and try again,” or “Call customer service to determine why your question was not answered,” or any other similar option or message.

Preferably, a subscriber is not directly debited each time that subscriber receives a question or provides an answer. Rather, in a preferred embodiment, subscribers are charged (or debited) in larger increments that are credited to the subscriber's account. For each transaction that incurs a fee, the invoice and debit use case 34 deducts the appropriate amount of the fee from that subscriber's account. This process continues until the subscriber's account reaches the minimum threshold, at which point the invoice and debit use case 34 debits the subscriber once again to replenish the subscriber's account. Such invoicing and debiting systems are well known in the art. For example, a subscriber can opt to have their credit card account automatically debited to replenish their balance with the lead generation and answer engine 10. Alternatively, subscribers may receive discounted rates for any mentioned or non-mentioned service for replenishing larger amounts of funds. For example, if a subscriber puts $100 in their account, they might actually be credited with $110.

The following is an example of a typical scenario and application of the lead generation and answer engine according to one embodiment of the present method and system:
Initially, a consumer doesn't know what kind of electrician to hire for lighting work. Looking at an advertisement in the traditional phone book directory or searching on the Internet does not answer specific questions that the consumer has, and certainly does not tell the consumer anything about the quality of one or more of the businesses that he does find. Calling several of the electricians is time consuming and frustrating.
The consumer logs onto the lead generation and answer engine and asks a question:
   “What should I look for when I am hiring an electrician for lighting work?”
The consumer chooses a category and sub-category for the question:
   “Home Construction/Repair”, “Electrician”
The consumer chooses a desired geographic area:
   “Zip Code 10101, radius of 10 miles”
The lead generation and answer engine anonymously forwards the consumer's question to multiple electricians within a 10 mile radius of the consumer's desired zip code.
Subscribers to the lead generation and answer engine (preferably certified Electricians) receive the consumer's question and determine if they want to answer the question. Several of the subscribers choose to provide a customized answer for a modest payment:
   “Make sure you get someone licensed by the state and who has at least five years of residential experience, also you should ask them about lighting work they have done previously. My company Acme Electricians is licensed in the state and has been doing this kind of work for over 20 years. If you have any questions, please contact us at . . . ”
The lead generation and answer engine sends an email to the consumer informing the consumer that they have several answers waiting for them, stored in the lead generation and answer engine.
The consumer logs onto the lead generation and answer engine, views the various answers, chooses which answers they like, and calls the corresponding electricians. One of the Electricians has a new customer, and the consumer has found a quality electrician for free, in an efficient, user friendly and hassle-free environment.

In one embodiment, the lead generation and answer engine 10 of the present method and system also displays sponsor or advertiser information, such as links or pop-up ads. Such advertising could be employed, for example, through the receive questions, publish questions and/or publish answers use cases 12, 22, 32. In alternate embodiments any suitable form of advertisement that might commonly be associated with or displayed or seen on a web page could be employed in the lead generation and answer engine 10. Alternatively, for consumers utilizing an audio-based aspect of the present method and system (e.g., receiving answers via telephone), audio advertisements could be heard.

In the lead generation and answer engine 10 of the present method and system, a consumer 14 may optionally limit the responses received (either directly or indirectly) from the publish answers use case 32 by any suitable criteria. The criteria can include any suitable criteria that may be desirable when looking for a service or product, for example geographical location, area code, postal code, or even facility type. For example, a consumer located in a telephone area code may only wish to receive responses from subscribers in the same telephone area code. Alternatively, a consumer may only wish to receive responses from subscribers that are in the same general geographical location, for example, city or town. In one embodiment, the consumer is able to limit the potential responses according to a geographical location that is someplace other than the present location of the consumer. For example, if the consumer has a summer home a significant distance away from his present location, the consumer may wish to limit answers to the location of his summer home. Thus, the consumer is able to conduct a search with customized answers of a geographic area where he is not presently located in order to obtain qualified goods, services or advice relevant to that distanced region. The consumer may also elect to filter responses from the publish answers use case 32 based on whether the subscriber is or has a mail order capability, if the question relates to a good or product.

Answer limitation criteria may also include a time period within which the service or product is desired. For example, if the consumer asks a question regarding the availability of a kennel to board his dog for the weekend, the consumer would prefer to limit available answers by such criteria (i.e., a date range) when asking the question. Thus, those skilled in the art will recognize that the receive questions use case 12 may include additional pull down menus or other input features designed to give the consumer options with which to limit the type of answers the consumer 14 may receive in response to the question. Alternatively, the consumer 14 may simply include the desired limitations within the text of the question, such that the criteria are implicitly taken into account by subscribers answering that question.

Similarly, the subscribers may also elect to only receive questions that meet certain criteria, as set forth above. For example, using the example of searching for a plumber, a plumber subscriber could choose to only receive questions regarding services that are in a certain geographical location. However, the plumber might also elect to receive any questions regarding plumbing goods, since the plumber subscriber may have a mail order or product shipping capability or facility. Thus, the additional selection criteria can allow for more targeted questions and answers.

In one embodiment, a consumer may send a request or query to the lead generation and answer engine regarding goods, products or services for sale and receive a response (automatic or manual) from the appropriate subscriber when the desired goods, products or services become available. For example, presently, in order for a consumer to determine if a certain store has an item in stock, or if, for example, a florist has a particular seasonal flower, for sale or bid, the consumer has to continually check and search the web site for the item(s), repeatedly call the store, or otherwise maintain a vigil with respect to the desired item or service. This can be time consuming, and if the consumer is not diligent, the consumer can miss a window of opportunity for the item(s).

In one embodiment, the consumer transmits an appropriate keyword and question to the lead generation and answer engine 10. This could include an email from the consumer that lists each item sought. The email could be in a particular format, such as the keyword in the subject line and the item in the text portion of the email, although any suitable format, such as XML, could be utilized. When the desired item or service becomes available, the consumer automatically receives notification from the website or subscriber, such as for example an email, that the item is available. The consumer could then either respond via email or access the website to engage in the purchasing or bidding process for the item(s) in accordance with the rules of the website facility.

In another embodiment of the present method and system, a question related to inventory or availability of a product or service may be asked by a consumer. The inventory question may be directed to a particular subscriber or group of subscribers. The forward questions use case 18 preferably forwards the inventory question to subscriber systems 52 that include scheduling and/or inventory information relevant to that particular subscriber. If and when the one of the subscriber systems has inventory or scheduling information relevant to the product, service or other requested information from the consumer's question, the accumulate answers use case 30 obtains such information from the relevant subscriber system 52 and generates a customized answer in response to the consumer's request. The customized answer may include advertisement and/or pricing information. The invoice and debit use case 34 charges the appropriate fee to the corresponding subscriber for providing an answer in response to the question. In this manner, consumers may efficiently and easily determine which subscriber (e.g., website, business, service company, etc.) has the desired goods or services and/or the time(s) at which they are available. This saves the consumer time, money and aggravation in not have to look around and contact various businesses to determine availability, pricing and scheduling.

In one embodiment, the consumer asks a question regarding availability or scheduling and/or requests an appointment with a subscriber (should a subscriber choose to respond). Preferably, if a subscriber responds to the consumer's question, such response provides the information that the consumer requested, as well, as appointment and/or scheduling information that may be directly linked to the subscriber's internal system. For example, the accumulate answers use case 30 may include a link to the subscriber's calendar system (such as Microsoft Outlook) with the appointment or appointment request already noted to the subscriber. Such appointments could be automatically generated by the accumulate answers use case 30 based on the response provided by the subscriber, or be manually submitted by the subscriber itself. The consumer, upon receiving the response, is able to confirm, reject or suggest changes to the appointment or reservation request and send such information back to the subscriber. Using the aforementioned example, the consumer may have sent a question to a kennel about boarding his dog for the weekend. Thus, the consumer asks a question about kennel service generally. Additionally, the question may include a specific date or date rage identifying when the consumer is interested in receiving such a service. In the dog kennel example, the subscriber (e.g., a kennel owner/operator) could answer the consumer's question, include contact information and note the consumer's request for a specific date range. Included with the response, the kennel sends a reservation or reservation request that is automatically stored in the kennel's calendar or reservation system. If the consumer is satisfied with the response, as well as the reservation suggestion, the consumer confirms the reservation with the kennel by responding to the subscriber. The accumulate answers use case 30 automatically updates the kennel's calendar and/or reservation system. Such a system is useful for a variety of different types of subscribers that provide goods or services based on scheduling, appointments or reservations, including, for example, hotels, rentals, personal services (e.g., kennels, spas, hairdressers) and professional services (e.g., electricians, plumbers, pool service). In one embodiment, the subscriber is charged an additional fee to be able to offer the calendar option to consumers. This feature is also very useful to consumers, since they need very little time to coordinate an appointment with a chosen subscriber.

The lead generation and answer engine 10 preferably includes a knowledge center use case 38 that displays questions and answers that a particular subscriber has participated in. Ratings, pictures, flash presentations, promotional material, the subscriber's own documents and any other material that a subscriber may desire to associate with a question and answer set may be included in the knowledge center use case 38. Preferably, subscribers are charged to utilize the knowledge center and/or store their information therein. The fee charged to the subscriber may be a set amount, or based upon options that the subscriber receives, a bidding amount, or an amount set by any other means.

Preferably, consumers may access the knowledge center use case 38 to find information pertaining to a particular subscriber, such as the subscriber's contact information, and can subsequently contact the subscribers directly (i.e., external to the lead generation and answer engine 10). Alternatively, consumers can choose to contact the subscriber through the lead generation and answer engine 10, thereby maintaining the privacy and/or anonymity of the consumer. Such contact mechanisms are discussed above, and may include a fee charged to the subscriber.

In one embodiment, if a subscriber chooses not to pay for access to a Knowledge Center, the lead generation and answer engine preferably provides the subscriber with a knowledge center free of charge, but without including the subscriber's contact information. In this embodiment, the consumer has the opportunity to contact the subscriber in one of the various ways previously described, with the subscriber being charged a fee to be contacted by the consumer.

In one embodiment, subscribers utilize one or more third parties to review questions entered by consumers. The third parties preferably generate customized answers to the questions as previously described. However, in this embodiment, the third parties preferably offer for the subscribers to sponsor the answer to the consumer. That is, the subscribers, if they so choose, may associate themselves with the answer to the consumer's question as provided by the third party. The sponsorship may include, for example, contact information, advertising and/or marketing material of the subscriber. Such sponsorship is preferably for a fee charged by the third party, and such fee may be in addition to the fee to answer the question charged by the lead generation and answer engine 10. Preferably, subscribers have the opportunity to review the questions and/or answer provided by the third parties prior to determining whether they will be a sponsor of a particular answer.

One advantage of the present method and system is that questions asked by consumers are forwarded to multiple subscribers that fit within the relevant keyword(s) and/or geographic criteria. Therefore, consumers potentially receive multiple answers from a single question (unless the consumer opts differently), from preferably certified subscribers. Moreover, consumers have the knowledge that the subscribers have paid a fee just for the right to access the question and/or provide an answer, thereby indicating that the subscriber is serious enough to spend money and time on the answer, thus helping to alleviate the consumer's “quality” concerns. The consumers also have the ability to compare and contrast the various answers and the subscriber which provided them (for example, using check references use case 36). In one embodiment, the publish answers use case 32 provides a chart, map or other comparison application, that allows the consumer to determine the location of the subscriber with respect to the consumer (or the consumer' designated point), what the subscriber changes for the relevant product or service, the answer provided by the subscribers, along with other criteria that make it easy to compare multiple subscribers and their answers including ratings by consumers.

Thus, the present method and system allows the consumer to receive relevant customized information in response to a question without the need for the user to navigate through what can be at times endless numbers of web pages or non-relevant information. Some additional benefits of the present method and system from the consumer's standpoint include:
Ability to easily receive relevant information without searching through numerous pages of information, either in the traditional manner (e.g., phone book directory) or in the more modem manner of conducting an Internet search (through a variety of search engine types);
Questions may be asked from a variety of different locations, in the format that is most beneficial to the consumer at that point in time;
Use of assigned categories increases the probability of receiving an accurate, relevant and timely answer from a qualified subscriber;
Subscribers are preferably certified, thereby reducing the number of faulty and/or meaningless responses;
Answers may be sent directly (through the lead generation and answer engine) to the consumer, in a format most convenient to the consumer (e.g., email, telephone, etc.), or may be published or retained on the lead generation and answer engine system for access by the consumer at a desired time;
Option to communicate directly with subscriber, external to the lead generation and answer engine;
Consumer anonymity is maintained throughout the process, and no personal information is shared, unless specified by the consumer.

With respect to the subscriber, some benefits of the present method and system include:
The ability to know or determine what a potential customer needs and when they need it;
Advertisements for potential business are generated in close proximity to when the consumer determined that he needs a particular product or service or generates a lead to that service;
Responding to questions is easy and efficient;
Ability to receive potential customers at a time and location that is convenient to the subscriber;
Ability to decide which consumers to market to;
Option to engage, for a nominal fee, the lead generation and answer engine for additional services related to answering questions (e.g., continued contact with the consumer, permanent ad placed within a published answer, etc.);
Leads from consumers are highly relevant, since the subscriber chooses for which keyword(s) and geographical area(s) the subscriber will answer questions.

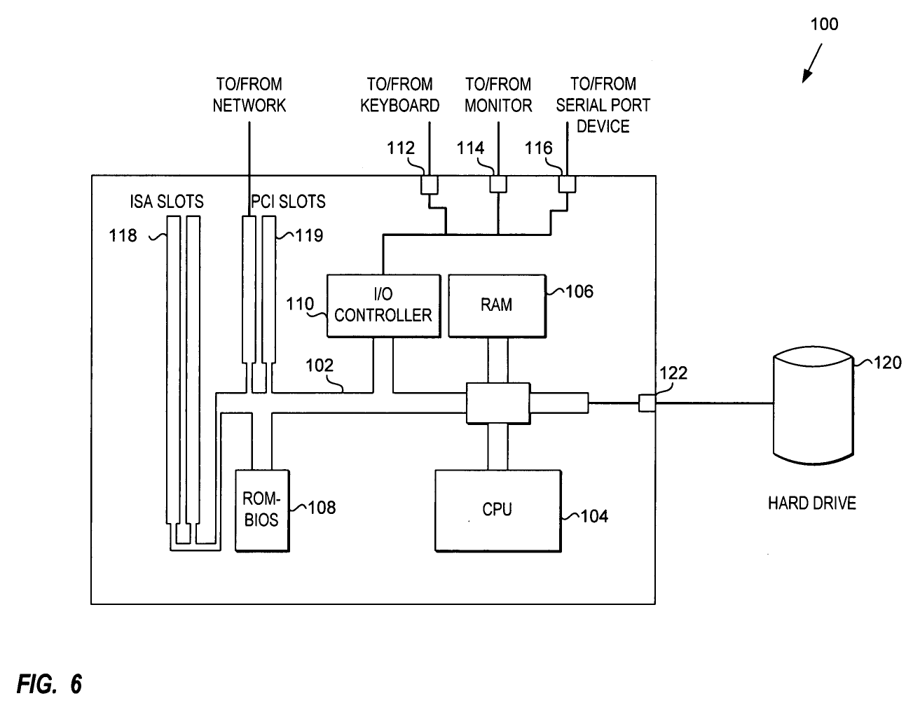

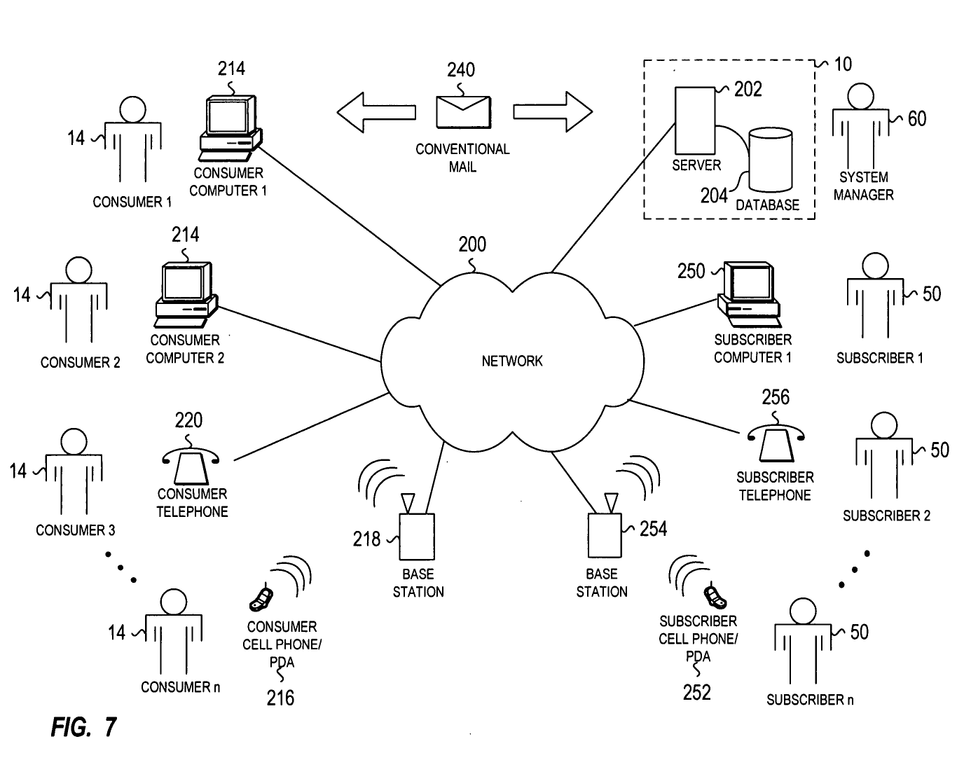

FIG. 6 illustrates a block diagram of a computer system 100 for a realization of the lead generation and answer engine 10 in accordance with the present method and system. A system bus 102 transports data amongst the CPU 104, the RAM 106, Read Only Memory—Basic Input Output System (ROM-BIOS) 108 and other components. The CPU 104 accesses a hard drive 120 through a disk controller 122. The standard input/output devices are connected to the system bus 102 through the I/O controller 110. A keyboard (not shown) is attached to the I/O controller 110 through a keyboard port 112 and a monitor (not shown) is connected through a monitor port 114. The serial port device (not shown) uses a serial port 116 to communicate with the I/O controller 110. Industry Standard Architecture (ISA) expansion slots 118 and Peripheral Component Interconnect (PCI) expansion slots 119 allow additional cards to be placed into the computer. In a preferred embodiment, a network card is available to interface a local area, wide area, or other network. The computer system 100 shown in FIG. 6 can be part of the lead generation and answer engine 10, or can be a processor present in another element of the network 200 (see FIG. 7).

FIG. 7 is a network diagram of the lead generation and answer engine in accordance with a preferred embodiment of the present method and system. The lead generation and answer engine 10 preferably communicates with the network 200, through which communication to, with and between the consumers 14 and subscribers 50 occurs. The network 200 may be any network or system generally known in the art, including the Internet, LAN, or other computer-based communication or information sharing system. The network 200 communicates with the lead generation and answer engine 10 via a server 202 that accesses data (e.g., questions, responses, profile and preference information, etc.) associated with the users of the lead generation and answer engine 10. The server 202 preferably has access to one or more databases or mass storage device 204 in which such data is organized and/or stored. The lead generation and answer engine 10 is preferably controlled or operated by a system manager 60. Consumers 14 and subscribers 50 preferably communicate with the network 200 using consumer computers 214 and subscriber computers 250, respectively. Consumer and subscriber computers 214, 250, their functions and capabilities are generally known in the art (see, for example, FIG. 6 and the discussion thereof), and a description thereof is omitted here for convenience only and should not be considered limiting.

In one embodiment, the consumers 14 and subscribers 50 access the network 200 and the lead generation and answer engine 10 via voice communication and/or conventional telephone service or devices 220, 256.

In one embodiment, the consumers 14 and subscribers 50 access the network 200 and the lead generation and answer engine 10 via conventional mail service 240.

In one embodiment, the consumers 14 and subscriber 50 access the network 200 and the lead generation and answer engine 10 using wireless device(s) 216, 252, such as cell phones, PDAs or any other similar device generally known in the art. Such wireless communications devices access the network 200 via respective base stations 218, 254.

The present invention may be implemented with any combination of hardware and software. If implemented as a computer-implemented apparatus, the present invention is implemented using means for performing all of the steps and functions described above.

The present invention can be included in an article of manufacture (e.g., one or more computer program products) having, for instance, computer useable media. The media has embodied therein, for instance, computer readable program code means for providing and facilitating the mechanisms of the present invention. The article of manufacture can be included as part of a computer system or sold separately.

Although the description above contains many specific examples, these should not be construed as limiting the scope of the invention but as merely providing illustrations of some of the presently preferred embodiments of this invention. Thus, the scope of the invention should be determined by the appended claims and their legal equivalents, rather than by the examples given.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I/We claim:

1. A method of lead generation comprising:
(a) receiving a question from a consumer;
(b) forwarding the question to one or more subscribers;
(c) charging at least one of the subscribers to respond to the question; and
(d) notifying the consumer of the response from the at least one of the subscribers.

2. The method of claim 1 further comprising:
(e) selecting to which of the subscribers to forward the question, wherein the selecting is based on a subscriber rating.

3. The method of claim 1 further comprising:
(e) assigning the question to at least one category, wherein the question is forwarded to the one or more subscribers based on the selected at least one category.

4. The method of claim 1 wherein the one or more subscribers individually determine whether or not to respond to the question.

5. The method of claim 1 wherein the response is based on human analysis of the content of the question.

6. The method of claim 1 wherein the response is customized based on the content of the question.

7. The method of claim 1 wherein the response includes an advertisement related to the at least one of the subscribers.

8. The method of claim 1 wherein the response to the question is attributed to the at least one of the subscribers.

9. The method of claim 1 wherein the at least one of the subscribers has been certified to respond to the question.

10. The method of claim 1 wherein the at least one of the subscribers is charged only if the response is presented to the consumer.

11. The method of claim 1 wherein the response is provided with respect to the service location of the at least one of the subscribers.

12. The method of claim 1 wherein the response is provided with respect to a designated geographic region.

13. The method of claim 12 wherein the geographic region is designated with respect to the content of the question.

14. The method of claim 1 wherein the forwarding of the question maintains the anonymity of the consumer.

15. The method of claim 1 wherein the at least one of the subscribers is charged based on a rating of the at least one of the subscribers.

16. The method of claim 1 further comprising:
(e) preventing the at least one of the subscribers from providing additional responses to the consumer.

17. A method of lead generation comprising:
(a) receiving a question from a consumer;
(b) forwarding the question to one or more subscribers, wherein the consumer selects at least a subset of the subscribers to receive the question;
(c) charging at least one of the subscribers for receiving the question from the consumer; and
(d) notifying the consumer of a response to the question from the at least one of the subscribers.

18. The method of claim 17 wherein the subset of subscribers is selected based on a subscriber rating.

19. The method of claim 17 further comprising:
(e) assigning the question to at least one category, wherein the question is forwarded to one or more subscribers based on the selected at least one category.

20. The method of claim 17 wherein the one or more subscribers individually determine whether or not to respond to the question.

21. The method of claim 17 wherein the response is based on human analysis of the content of the question.

22. The method of claim 17 wherein the response is customized based on the content of the question.

23. The method of claim 17 wherein the response includes an advertisement related to the at least one of the subscribers.

24. The method of claim 17 wherein the response to the question is attributed to the at least one of the subscribers.

25. The method of claim 17 wherein the at least one of the subscribers has been certified to respond to the question.

26. The method of claim 17 wherein step (d) includes presenting the response to the consumer.

27. The method of claim 17 wherein the response is provided with respect to the service location of the at least one of the subscribers.

28. The method of claim 17 wherein the response is provided with respect to a designated geographic region.

29. The method of claim 28 wherein the geographic region is designated with respect to the content of the question.

30. The method of claim 17 wherein the forwarding of the question maintains the anonymity of the consumer.

31. A method of lead generation comprising:
(a) receiving a question from a consumer;
(b) forwarding the question to one or more subscribers;
(c) presenting the consumer with a response from at least one of the subscribers; and
(d) charging the at least one of the subscribers to present the response to the consumer.

32. The method of claim 31 further comprising:
(e) selecting to which of the subscribers to forward the question, wherein the selecting is based on a subscriber rating.

33. The method of claim 31 further comprising:
(e) assigning the question to at least one category, wherein the question is forwarded to one or more subscribers based on the selected at least one category.

34. The method of claim 31 wherein the one or more subscribers individually determine whether or not to respond to the question.

35. The method of claim 31 wherein the response is based on human analysis of the content of the question.

36. The method of claim 31 wherein the response is customized based on the content of the question.

37. The method of claim 31 wherein the response includes an advertisement related to the at least one of the subscribers.

38. The method of claim 31 wherein the response to the question is attributed to the at least one of the subscribers.

39. The method of claim 31 wherein the at least one of the subscribers has been certified to respond to the question.

40. The method of claim 31 wherein the response is provided with respect to the service location of the at least one of the subscribers.

41. The method of claim 31 wherein the response is provided with respect to a designated geographic region.

42. The method of claim 41 wherein the geographic region is designated with respect to the content of the question.

43. The method of claim 31 wherein the forwarding of the question maintains the anonymity of the consumer.

44. A method of lead generation comprising:
(a) receiving a question from a consumer;
(b) generating a response to the question;
(c) charging at least one of a plurality of subscribers to sponsor the response to the question; and
(d) notifying the consumer of the response to the question.

45. The method of claim 44 further comprising:
(e) presenting the plurality of subscribers with the response prior to notifying the consumer, such that the subscribers determine whether to sponsor the response to the question.

46. The method of claim 44 further comprising:
(e) assigning the question to at least one category, wherein the question is presented to one or more subscribers for sponsorship based on the selected at least one category.

47. The method of claim 44 wherein the one or more subscribers individually determine whether or not to respond to the question.

48. The method of claim 44 wherein the response is based on human analysis of the content of the question.

49. The method of claim 44 wherein the response is customized based on the content of the question.

50. The method of claim 44 wherein the response includes an advertisement related to the at least one of the subscribers.

51. The method of claim 44 wherein the at least one of the subscribers has been certified to respond to the question.

52. The method of claim 44 wherein the at least one of the subscribers is charged only if the response is presented to the consumer.

53. The method of claim 44 wherein the response is provided with respect to the service location of the at least one of the subscribers.

54. The method of claim 44 wherein the response is provided with respect to a designated geographic region.

55. The method of claim 54 wherein the geographic region is designated with respect to the content of the question.

56. A system for generating a lead comprising:
(a) a first receiver for receiving a question from a consumer;
(b) a forwarding engine for forwarding the question from the consumer to one or more subscribers;
(c) a second receiver for receiving a response, wherein the content of the response is based on human analysis of the content of the question by at least one of the subscribers;
(d) a debiting system for charging the at least one of the subscribers to respond to the question; and
(e) a reply engine for notifying the consumer of the response.

57. The system of claim 56 further comprising:
(f) a selection system for selecting to which of the subscribers to forward the question, wherein the selecting is based on a subscriber rating.

58. The system of claim 56 further comprising:
(f) a category assignment system for assigning the question to at least one category, wherein the question is forwarded to one or more subscribers based on the selected at least one category.

59. The system of claim 56 wherein the one or more subscribers individually determine whether or not to respond to the question.

60. The system of claim 56 wherein the response is customized based on the content of the question.

61. The system of claim 56 wherein the response includes an advertisement related to the at least one of the subscribers.

62. The system of claim 56 wherein the response to the question is attributed to the at least one of the subscribers.

63. The system of claim 56 wherein the at least one of the subscribers has been certified to respond to the question.

64. The system of claim 56 wherein the debiting system charges the at least one of the subscribers only if the reply engine presents the response to the consumer.

65. The system of claim 56 wherein the response is provided with respect to the service location of the at least one of the subscribers.

66. The system of claim 56 wherein the response is provided with respect to a designated geographic region.

67. The system of claim 66 wherein the geographic region is designated with respect to the content of the question.

68. The system of claim 56 wherein the forwarding engine maintains the anonymity of the consumer.

69. The system of claim 56 further comprising:
(f) a scheduling system for linking a time associated with the response to the at least one of the subscribers.

70. In an Internet-based system, a method of lead generation comprising:
(a) receiving a question from a consumer;
(b) forwarding the question to one or more subscribers, wherein the subscribers are contractually obligated to advertise or make purchases through the system;
(c) receiving a response to the question from at least one of the subscribers; and
(d) presenting the consumer with the response from the at least one of the subscribers, wherein the response is presented to the consumer in exchange for the at least one of the subscribers satisfying at least one of the contractual obligations with the system.

71. The method of claim 70 further comprising:
(e) selecting to which of the subscribers to forward the question, wherein the selecting is based on a subscriber rating.

72. The method of claim 70 further comprising:
(e) assigning the question to at least one category, wherein the question is forwarded to the one or more subscribers based on the selected at least one category.

73. The method of claim 70 wherein the one or more subscribers individually determine whether or not to respond to the question.

74. The method of claim 70 wherein the response is based on human analysis of the content of the question.

75. The method of claim 70 wherein the response is customized based on the content of the question.

76. The method of claim 70 wherein the response includes an advertisement related to the at least one of the subscribers.

77. The method of claim 70 wherein the response to the question is attributed to the at least one of the subscribers.

78. The method of claim 70 wherein the at least one of the subscribers has been certified to respond to the question.

79. The method of claim 70 wherein the response is provided with respect to the service location of the at least one of the subscribers.

80. The method of claim 70 wherein the response is provided with respect to a designated geographic region.

81. The method of claim 80 wherein the geographic region is designated with respect to the content of the question.

82. The method of claim 70 wherein the forwarding of the question maintains the anonymity of the consumer.
